(19) United States
(12) Patent Application Publication
(10) Pub. No.: US 2026/0019467 A1
(43) Pub. Date: Jan. 15, 2026

(54) INTERNET OF THINGS (IOT)-BASED LARGE-MODEL SYSTEMS AND METHODS FOR EMERGENCY SUPERVISION OF URBAN LIFELINE GAS PIPELINES

(71) Applicant: CHENGDU QINCHUAN IOT TECHNOLOGY CO., LTD., Chengdu (CN)

(72) Inventors: Hanshu SHAO, Chengdu (CN); Yong LI, Chengdu (CN); Junyan ZHOU, Chengdu (CN)

(73) Assignee: CHENGDU QINCHUAN IOT TECHNOLOGY CO., LTD., Chengdu (CN)

(21) Appl. No.: 19/337,895

(22) Filed: Sep. 23, 2025

(30) Foreign Application Priority Data
Sep. 3, 2025 (CN) 202511251014.5

(51) Int. Cl. H04L 67/12; G01H 9/00; G16Y 10/35; G16Y 40/10; G16Y 40/35

(52) U.S. Cl. CPC H04L 67/12; G01H 9/004; G16Y 10/35; G16Y 40/10; G16Y 40/35

(57) ABSTRACT

An Internet of Things (IoT)-based large-model system and a method for emergency supervision of an urban lifeline gas pipeline are provided. The system includes an emergency supervision management platform being configured to: control a distributed optical fiber to obtain a first stress distribution and a first displacement distribution of a buried pipeline, wherein the distributed optical fiber is located on the buried pipeline; determine a to-be-detected region corresponding to the buried pipeline based on the first stress distribution and the first displacement distribution; control an unmanned vehicle to detect the buried pipeline within the to-be-detected region to obtain detection data; determine a target valve based on the detection data, and send a valve control instruction; and control the target valve to close based on the valve control instruction.

### CROSS-REFERENCE TO RELATED APPLICATIONS

This application claims priority to Chinese Patent Application No. 202511251014.5, filed on Sep. 3, 2025, the entire content of which is hereby incorporated by reference.

### TECHNICAL FIELD

The present disclosure relates to the field of gas pipeline regulation, and in particular to an Internet of Things (IoT)-based large-model system and a method for emergency supervision of an urban lifeline gas pipeline.

### BACKGROUND

With the continuous extension of urban gas pipeline networks, the real-time perception of the operation status and emergency response for deeply buried gas pipelines has become critical to ensuring gas supply safety, due to highly concealed and complex operation environments of the deeply buried gas pipelines. Despite continuous advancements in monitoring and inspection technologies, practical applications still face challenges such as limited coverage and insufficient response efficiency. There remains a need for improvement in rapid localization and emergency supervision, particularly in sudden incidents.

Therefore, it is desirable to provide an Internet of Things (IoT)-based large-model system for emergency supervision of an urban lifeline gas pipeline, which enables the monitoring of relevant parameters of the deeply buried gas pipelines through data interactions between IoT platforms and facilitates corresponding measures, thereby enhancing the safety of urban gas usage.

### SUMMARY

One or more embodiments of the present disclosure provide an Internet of Things (IoT)-based large-model system for emergency supervision of an urban lifeline gas pipeline. The system includes an emergency supervision management platform configured to: control a distributed optical fiber to obtain a first stress distribution and a first displacement distribution of a buried pipeline, wherein the distributed optical fiber is located on the buried pipeline; determine a to-be-detected region corresponding to the buried pipeline based on the first stress distribution and the first displacement distribution; control an unmanned vehicle to detect the buried pipeline within the to-be-detected region to obtain detection data; determine a target valve based on the detection data, and send a valve control instruction; and control the target valve to close based on the valve control instruction.

One or more embodiments of the present disclosure provide a method for emergency supervision of an urban lifeline gas pipeline. The method is performed by an emergency supervision management platform. The method includes: controlling a distributed optical fiber to obtain a first stress distribution and a first displacement distribution of a buried pipeline, wherein the distributed optical fiber is located on the buried pipeline; determining a to-be-detected region corresponding to the buried pipeline based on the first stress distribution and the first displacement distribution; controlling an unmanned vehicle to detect the buried pipeline within the to-be-detected region to obtain detection data; determining a target valve based on the detection data, and sending a valve control instruction; and controlling the target valve to close based on the valve control instruction.

### BRIEF DESCRIPTION OF THE DRAWINGS

The present disclosure will be further illustrated by way of exemplary embodiments, which will be described in detail with reference to the accompanying drawings. These embodiments are not limiting, and in these embodiments, the same numbering denotes the same structure, wherein:

FIG. 1 is a block diagram illustrating a platform structure of an Internet of Things (IoT)-based large-model system for emergency supervision of an urban lifeline gas pipeline according to some embodiments of the present disclosure;

FIG. 2 is a flowchart illustrating an exemplary process for emergency supervision of an urban lifeline gas pipeline according to some embodiments of the present disclosure;

FIG. 3 is a schematic diagram illustrating deployment of gas pipelines according to some embodiments of the present disclosure;

FIG. 4 is a schematic diagram illustrating a prediction model according to some embodiments of the present disclosure; and

FIG. 5 is a flowchart illustrating an exemplary process for adjusting a pulse width according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose. The term “and/or”, as used herein, is merely a way of describing the associative relationship of an associated object, indicating that three relationships can exist, e.g., A and/or B, which may be represented as: An alone, both A and B, and B alone.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

In some embodiments of the present disclosure, a to-be-detected region in a buried pipeline where an abnormality is likely to occur is identified based on stress distribution data and displacement distribution data collected by a distributed optical fiber. Based on the characteristics of the to-be-detected region, an unmanned vehicle is dispatched to perform mobile refined detection to obtain more accurate on-site information. Furthermore, based on detection data feedback from the unmanned vehicle, a target valve that requires emergency shutdown is identified and a valve control instruction is sent to automatically close the target valve, thereby achieving closed-loop management from condition awareness to emergency response.

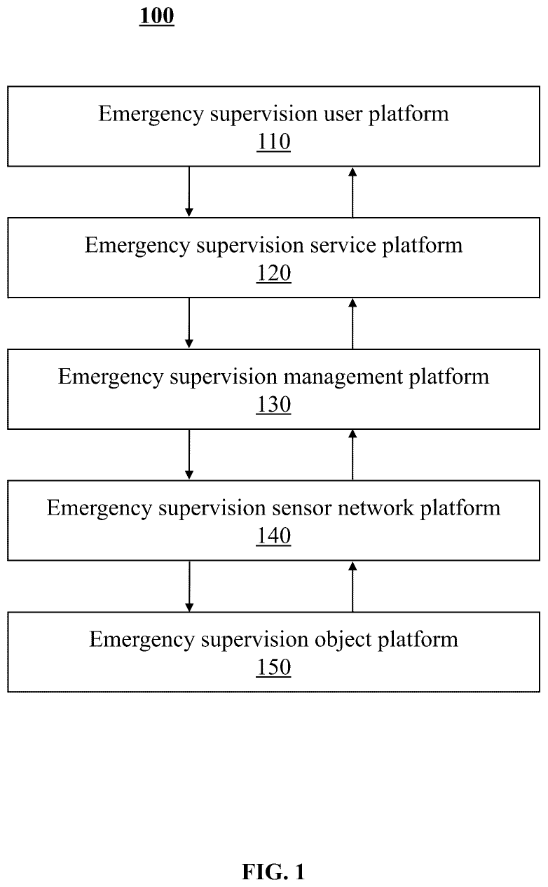

FIG. 1 is a block diagram illustrating a platform structure of an Internet of Things (IoT)-based large-model system for emergency supervision of an urban lifeline gas pipeline according to some embodiments of the present disclosure.

In some embodiments, as shown in FIG. 1, an Internet of Things (IoT)-based large-model system 100 for emergency supervision of an urban lifeline gas pipeline (also referred to as the system 100) may include an emergency supervision user platform 110, an emergency supervision service platform 120, an emergency supervision management platform 130, an emergency supervision sensor network platform 140, and an emergency supervision object platform 150.

The emergency supervision user platform 110 refers to a platform that interacts with a user (e.g., supervision personnel, a citizen). In some embodiments, the emergency supervision user platform 110 includes a terminal device. For example, the terminal device may include a mobile device, a tablet, a console, or the like. The emergency supervision user platform 110 may interact bi-directionally with the emergency supervision service platform 120.

The emergency supervision service platform 120 refers to a platform for receiving and transmitting data and/or information. In some embodiments, the emergency supervision service platform 120 is configured as a server or a processor. The emergency supervision service platform 120 may interact bi-directionally with the emergency supervision user platform 110 and the emergency supervision management platform 130.

The emergency supervision management platform 130 refers to an integrated management platform that manages, integrates, and coordinates connections and collaborations among a plurality of platforms. In some embodiments, the emergency supervision management platform 130 is configured as a server or a processor. The emergency supervision management platform 130 may interact bi-directionally with the emergency supervision service platform 120 and the emergency supervision sensor network platform 140. For example, the emergency supervision management platform 130 may obtain detection data from the emergency supervision object platform 150 via the emergency supervision sensor network platform 140. As another example, the emergency supervision management platform 130 may issue a regulation instruction (e.g., a valve control instruction, etc.) to the emergency supervision object platform 150 via the emergency supervision sensor network platform 140 to control the emergency supervision object platform 150 to perform operations such as controlling a target valve to close, etc., based on the regulation instruction. More descriptions regarding the operations such as closing the target valve, etc., performed by the emergency supervision object platform 150 may be found in subsequent content and related descriptions.

The emergency supervision sensor network platform 140 refers to a platform for comprehensive management of sensor information. In some embodiments, the emergency supervision sensor network platform 140 is configured as a communication network, a gateway, etc. The emergency supervision sensor network platform 140 may interact bi-directionally with the emergency supervision management platform 130 and the emergency supervision object platform 150.

The emergency supervision object platform 150 refers to a platform for generation of supervision information and execution of control information. In some embodiments, the emergency supervision object platform 150 is configured as a distributed fiber optic sensor, an unmanned vehicle, or the like. The emergency supervision object platform 150 may interact bi-directionally with the emergency supervision sensor network platform 140. For example, the emergency supervision object platform 150 may obtain detection data of a plurality of target sections of a buried pipeline and upload the detection data to the emergency supervision management platform 130 via the emergency supervision sensor network platform 140. As another example, the emergency supervision object platform 150 may perform a regulation operation in response to the regulation instruction issued by the emergency supervision management platform 130 via the emergency supervision sensor network platform 140.

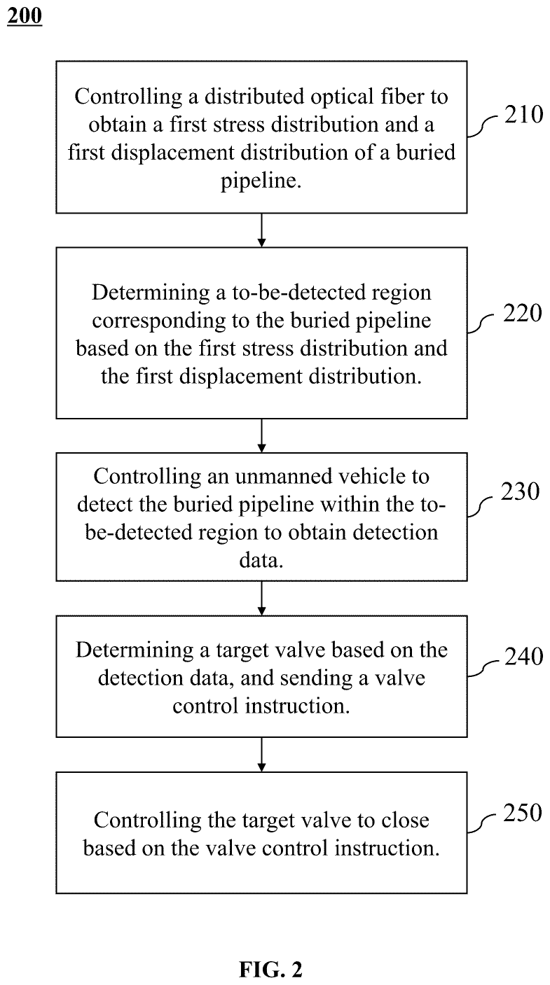

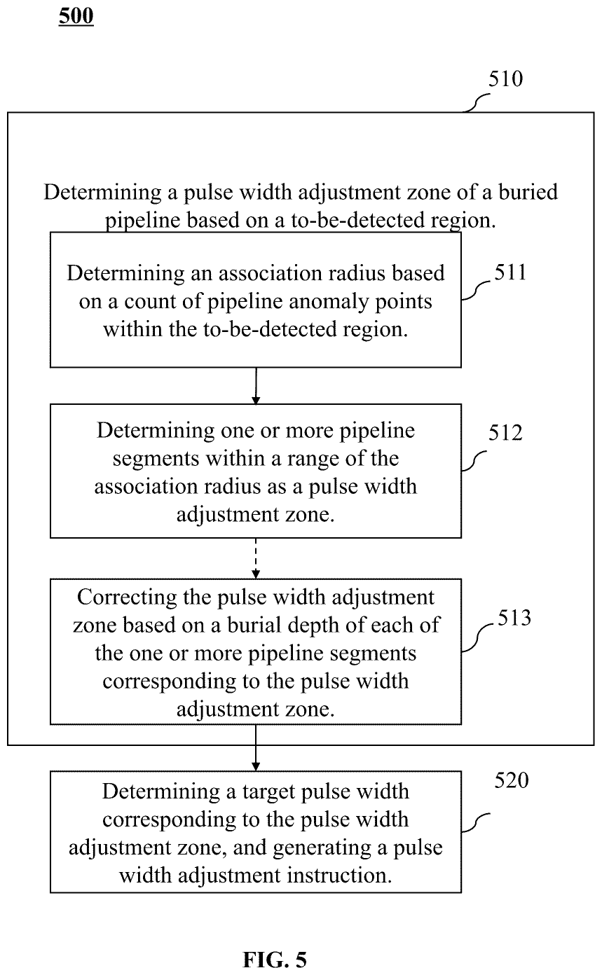

The distributed optical fiber sensor refers to a device that senses a change in an environment by analyzing a change in a transmission feature of an optical signal in an optical fiber. In some embodiments, the distributed optical fiber sensor may collect a plurality of stress values (e.g., a first stress distribution and a second stress distribution) and a plurality of displacement values (e.g., a first displacement distribution and a second displacement distribution) of the buried pipeline. More descriptions regarding the plurality of stress values and the plurality of displacement may be found in FIGS. 2 and 5 and related descriptions below.

More descriptions regarding the aforementioned platforms may be found in FIGS. 2-5 and related descriptions below.

In some embodiments of the present disclosure, the system 100 can establish an information operation closed loop among various functional platforms. Under the unified management of the emergency supervision management platform, these platforms operate in a coordinated and regular manner, achieving digitalized and intelligent emergency monitoring of deeply buried urban gas pipelines.

It should be noted that the above descriptions of the system 100 and its platform are only for the convenience of the descriptions, and do not limit the present disclosure to the scope of the cited embodiments. It is to be understood that for a person skilled in the art, after understanding the principle of the system, it is possible to arbitrarily combine various platforms or constitute a sub-system to connect with other platforms without departing from the principle.

FIG. 2 is a flowchart illustrating an exemplary process for emergency supervision of an urban lifeline gas pipeline according to some embodiments of the present disclosure.

In some embodiments, the method for emergency supervision of an urban lifeline gas pipeline may be performed by the emergency supervision management platform 130. As shown in FIG. 2, the process 200 includes the following operations.

In 210, a distributed fiber optic may be controlled to obtain a first stress distribution and a first displacement distribution of a buried pipeline.

The distributed optical fiber, i.e., a distributed optical fiber sensor, refers to a sensor that monitors the buried gas pipeline along an optical fiber transmission path through a distributed optical fiber detection technology.

The buried pipeline refers to a gas pipeline or an associated facility that is buried under a surface of a ground.

The first stress distribution refers to a distribution of stress change values measured along the buried pipeline relative to a baseline state of an initially laid pipeline its initially laid state. In some embodiments, the first stress distribution may include stress values of a plurality of pipeline segments or a plurality of pipeline nodes.

A pipeline node refers to a junction that connects two or more pipeline segments. In some embodiments, valves may be provided at the pipeline nodes.

The first displacement distribution refers to a distribution of displacements measured along the buried pipeline relative to an initially laid position of the buried pipeline. In some embodiments, the first displacement distribution may include displacements of a plurality of pipeline segments or a plurality of pipeline nodes.

In some embodiments, the emergency supervision management platform may obtain the first stress distribution and the first displacement distribution via the distributed optical fiber.

In 220, a to-be-detected region corresponding to the buried pipeline may be determined based on the first stress distribution and the first displacement distribution.

The to-be-detected region refers to a region potentially at risk and requiring further detection. In some embodiments, the to-be-detected region may cover one or more pipeline segments.

In some embodiments, the emergency supervision management platform may define the to-be-detected region as a region enclosed by pipeline segments or pipeline nodes whose stress values in the first stress distribution exceed a first preset threshold, or a region enclosed by pipeline segments or pipeline nodes whose displacements in the first displacement distribution exceed a second preset threshold. The first preset threshold and the second preset threshold may be set based on experience.

In 230, an unmanned vehicle may be controlled to detect the buried pipeline within the to-be-detected region to obtain detection data.

The unmanned vehicle refers to a mobile detection platform with an autonomous detection capability. In some embodiments, the unmanned vehicle may carry a plurality of sensors (e.g., ultrasound devices, ground-penetrating radars, etc.).

The detection data refers to data obtained from the detection of the buried pipeline. In some embodiments, the detection data includes metal loss, corrosion layer integrity, gas concentration, temperature, or the like of the pipeline segment or the pipeline node.

In some embodiments, the detection data may be obtained by detecting the buried pipeline through the unmanned vehicle.

In 240, a target valve may be determined based on the detection data.

The target valve refers to a valve that needs to be regulated. In some embodiments, the target valve may be a valve that needs to be closed.

In some embodiments, the emergency supervision management platform may determine the target valve through a vector matching manner based on the detection data.

By way of example, the emergency supervision management platform may designate historical data that satisfies a screening condition as first sample data. The screening condition may include that no accident occurred within a first preset time period after valve closure in the historical data. The first sample data includes the detection data of the to-be-detected region and valves that are actually closed in the to-be-detected region.

The emergency supervision management platform may construct current detection data into a first to-be-matched vector, and construct each detection data in the first sample data into a first target vector. Then the emergency supervision management platform determines a plurality of first similarities between a plurality of first target vectors and the first to-be-matched vector, and determine the actually closed valve corresponding to the first target vector with the highest first similarity as the target valve. The first similarity may be a Euclidean distance, a cosine similarity, or the like.

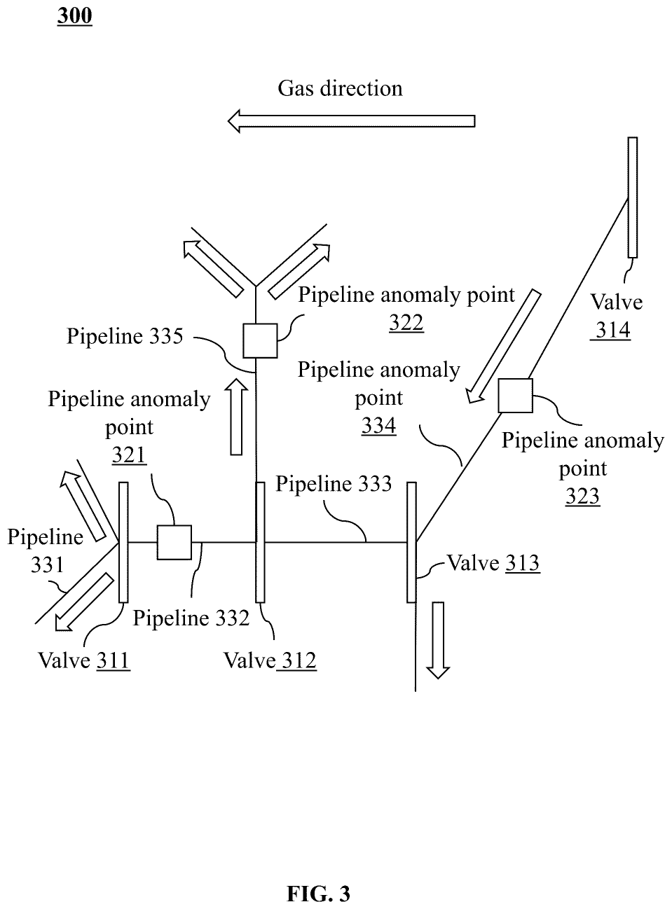

More descriptions regarding the target valve may be found in FIG. 3 and the related descriptions.

In 250, the target valve may be controlled to close based on a valve control instruction.

The valve control instruction refers to an instruction for regulating opening and closing of a valve. In some embodiments, the valve control instruction includes an instruction to close the target valve.

In some embodiments, the emergency supervision management platform may control the target valve to close based on the valve control instruction.

In some embodiments of the present disclosure, the emergency supervision management platform utilizes a deployed distributed optical fiber network to achieve round-the-clock remote monitoring of the buried pipeline. The emergency supervision management platform automatically identifies a region with abnormal vibrations and stress changes, and accurately locates the to-be-detected region where risks may exist. Then the unmanned vehicle detects the to-be-detected region in a refined manner, and based on the detection data obtained from the detection, the valves in the to-be-detected region can be repaired. This approach enables rational allocation of detection resources while simultaneously identifying defects in the buried pipeline in a timely manner for targeted maintenance, thereby enhancing the safety of the buried pipeline.

In some embodiments, the emergency supervision management platform may at least one pipeline anomaly point of the buried pipeline based on the detection data, and determine the target valve based on the at least one pipeline anomaly point. More descriptions regarding the detection data, the buried pipeline, and the target valve may be found in FIG. 2 and the related descriptions.

A pipeline anomaly point refers to a location in the buried pipeline that may be potentially defective. In some embodiments, the pipeline anomaly point may be a pipeline segment or a pipeline node.

In some embodiments, the emergency supervision management platform determines a pipeline segment or a pipeline node as a pipeline anomaly point if the pipeline segment or the pipeline node meets at least one of the following conditions based on the detection data: the metal loss of the pipeline segment or the pipeline node exceeds a loss threshold, the coating integrity the pipeline segment or the pipeline node falls below an integrity threshold, the gas concentration of the pipeline segment or the pipeline node exceeds a concentration threshold, or the temperature of the pipeline segment or the pipeline node exceeds a temperature threshold. The loss threshold, the integrity threshold, the concentration threshold, and the temperature threshold may be preset based on experience.

In some embodiments, the emergency supervision management platform may determine the target valve by querying a first preset table. The first preset table includes pipeline anomaly points and target valves corresponding to the pipeline anomaly points, and the first preset table may be constructed by a technician based on historical data and prior experience.

In some embodiments, the emergency regulatory management platform may determine a regulatory coverage range of at least one candidate valve, the at least one candidate valve being generated based on the at least one pipeline anomaly point; determine an influence impact value and coverage data of the at least one candidate valve based on the regulatory coverage range; determine a control influence value of the at least one candidate valve based on the at least one pipeline anomaly point; determine a comprehensive score of the at least one candidate valve by weighting the influence impact value and the control influence value; and determine the target valve based on the comprehensive score and the coverage data.

A candidate valve refers to a valve that may be determined as the target valve. The at least one candidate valve may be preset by the system 100 or randomly generated by the system 100.

In some embodiments, the emergency supervision management platform may generate the at least one candidate valve based on the at least one pipeline anomaly point. For example, the emergency supervision management platform may determine all upstream valve(s) of the at least one pipeline anomaly point as the at least one candidate valve. As another example, the emergency supervision management platform may determine a preset count of valves along a direction opposite to a direction a gas flow starting from the at least one pipeline anomaly point as the at least one candidate valve. The preset count may be preset by the system 100.

The regulatory coverage range refers to a range covering buried pipelines affected by a valve. In some embodiments, the regulatory coverage range may include a range covering upstream and downstream buried pipelines affected by the valve. FIG. 3 is a schematic diagram illustrating deployment of gas pipelines according to some embodiments of the present disclosure. As shown in FIG. 3, the diagram includes valves 311 to 314, pipeline anomaly points 321 to 323, and pipelines 331 to 334 (valves and pipelines not involved in the description of this embodiment are not labeled). The arrows indicate the direction of the gas flow, and the regulatory coverage range of the valve 312 may include an upstream pipeline 333, an upstream pipeline 334, a downstream pipeline 332, and a downstream pipeline 335, i.e., the above pipelines are the buried pipelines affected by the valve 312.

In some embodiments, the regulatory coverage range may be preset by the system 100.

In some embodiments, the emergency supervision management platform may obtain historical data of a candidate valve among the at least one candidate valve that satisfies a preset condition, the historical data including first pipeline data and second pipeline data; determine an upstream critical pipeline and a downstream critical pipeline of the candidate valve satisfying the preset condition based on the historical data; and generate the regulatory coverage range of the candidate valve satisfying the preset condition based on the upstream critical pipeline and the downstream critical pipeline.

The preset condition refers to a condition for filter valves.

In some embodiments, the preset condition may include that the valve is located within a preset radius of the pipeline anomaly point. The preset radius is set based on experience.

The historical data refers to information stored by the system regarding all buried pipelines and valves. For example, the historical data includes data related to valve regulation. In some embodiments, the historical data includes the first pipeline data and the second pipeline data.

The first pipeline data refers to data generated before regulation of the candidate valve. In some embodiments, the first pipeline data includes data such as gas flow rate, gas pressure, or the like, of all buried pipelines affected by the candidate valve when the candidate valve is open.

The second pipeline data refers to data generated after the candidate valve is regulated. The second pipeline data includes data such as gas flow rate, gas pressure, or the like, of all buried pipelines within a second preset time after the candidate valve is closed. The second preset time is set based on experience.

The upstream critical pipeline refers to a farthest pipeline, along the direction opposite to the direction of the gas flow starting from the candidate valve, that is affected by the opening (or closing) of the candidate valve. Being affected by the opening (or closing) of the candidate valve refers to that when a difference in gas flow rate, gas pressure, etc., before and after the opening (or closing) of the candidate valve is greater than a corresponding difference threshold.

The downstream critical pipeline refers to a farthest pipeline, along the direction of the gas flow starting from the candidate valve, that is affected by the opening (or closing) of the candidate valve.

In some embodiments, the emergency supervision management platform may start from the candidate valve and extend in the direction opposite to the direction of the gas flow. When the difference in at least one of the gas flow rate or the gas pressure of a pipeline before and after valve adjustment is lower than the first preset threshold for the first time, the pipeline is determined as the upstream critical pipeline. The emergency supervision management platform may start from the candidate valve and extend in the direction of the gas flow. When the difference in at least one of the gas flow rate or the gas pressure of a pipeline before and after valve adjustment is lower than a second preset threshold for the first time, the pipeline is determined as the downstream critical pipeline. The first preset threshold and the second preset threshold may be set based on experience.

In some embodiments, the regulatory coverage range of the candidate valve may be generated based on a pipeline between the upstream critical pipeline and the candidate valve, and a pipeline between the downstream critical pipeline and the candidate valve.

In some embodiments of the present disclosure, the upstream critical pipeline and the downstream critical pipeline are accurately identified by analyzing the first pipeline data and the second pipeline data in the historical regulation data of the candidate valve, and the regulatory coverage range adapted to the valve is dynamically generated to ensure the precision of emergency regulation.

The influence impact value refers to a parameter that measures an extent of influence of the opening (or closing) of the valve on the buried pipeline.

In some embodiments, the influence impact value may be a sum of a count of upstream pipelines and a count of downstream pipelines of the valve that are affected by the opening (or closing) of the valve.

The coverage data refers to data related to the at least one pipeline anomaly point that may block the gas flow after the valve is closed.

In some embodiments, the coverage data may characterize the status of all pipeline anomaly points of downstream of the at least one candidate valve. For example, as shown in FIG. 3, there are no pipeline anomaly points downstream of the valve 311, so the coverage data of the valve 311 indicates no pipeline anomaly points. There is the pipeline anomaly point 321 downstream of the valve 312, so the coverage data of the valve 312 includes the pipeline anomaly point 321.

The control influence value refers to a count of pipeline anomaly points that may directly block the gas flow when the valve is closed.

In some embodiments, the control influence value may be the count of pipeline anomaly points in the coverage data. For example, as shown in FIG. 3, there are no pipeline anomaly points downstream of the valve 311, thus the control influence value of the valve 311 is 0; the pipeline anomaly points downstream of the valve 312 include the abnormal point 321, thus the control influence value of the valve 312 is 1.

The comprehensive score refers to a parameter that measures a control efficiency after the pipeline anomaly point(s) are repaired and risks have been eliminated.

In some embodiments, for each of the at least one candidate valve, the emergency supervision management platform may normalize the control influence value and the influence impact value of the candidate valve, perform a weighted summation on the normalized control influence value and the normalized influence impact value, and designate the result of the weighted summation as the comprehensive score. Weights of the control influence value and the influence impact value may be set based on experience.

In some embodiments, the emergency supervision management platform may select a candidate valve with a highest comprehensive score as the target valve.

In some embodiments of the present disclosure, the regulation efficiency of the pipeline anomaly point of the candidate valve is accurately evaluated based on the coverage data and the control influence value, and the regulation coverage range of the valve for the buried pipeline is reflected through the influence impact value. Furthermore, by integrating the comprehensive score, a balanced relationship between control efficiency and network disturbance is rationally maintained.

In some embodiments of the present disclosure, the pipeline anomaly point can be located quickly based on the detection data, so that the target valve can be accurately identified, which significantly improves defect identification efficiency and enhances the targeting of valve maintenance, thereby reducing leakage risks and ensuring safe pipeline operation.

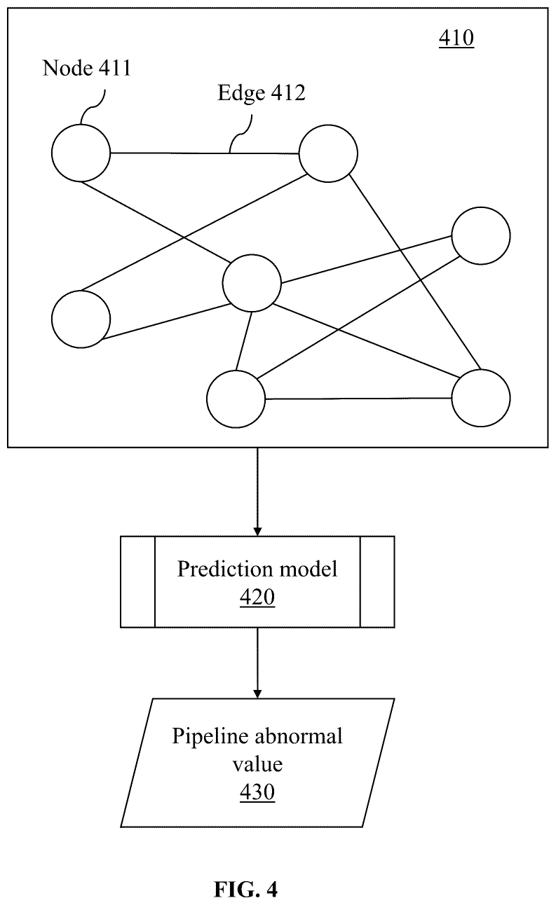

FIG. 4 is a schematic diagram illustrating an exemplary prediction model according to some embodiments of the present disclosure.

In some embodiments, the emergency supervision management platform 130 may control an unmanned vehicle to perform a burial depth detection on a buried pipeline within a to-be-detected region to obtain burial depth data; construct a buried pipeline map 410 based on detection data and the burial depth data; and determine at least one pipeline anomaly point through a prediction model 420 based on the buried pipeline map, the prediction model being a machine learning model.

The burial depth data refers to data reflecting a situation of the buried pipeline installed underground.

In some embodiments, the burial depth data may include a burial depth of a pipeline segment or a pipeline node.

In some embodiments, the burial depth data may be obtained through detection by the unmanned vehicle.

The prediction model 420 refers to a model for determining the at least one pipeline anomaly point. In some embodiments, the prediction model is a machine learning model such as a Graph Neural Network (GNN) model.

In some embodiments, an input of the prediction model 420 may include the buried pipeline map 410, and an output of the prediction model 420 may be a pipeline abnormal value 430. The pipeline abnormal value 430 may include a pipeline abnormal value corresponding to each node and/or edge of the buried pipeline map.

The pipeline abnormal value refers to a parameter that describes whether an anomaly exists in the pipeline. In some embodiments, the pipeline abnormal value may be a Boolean value, such as 0 or 1, where 1 indicates that there is an anomaly in the pipeline and 0 indicates that there is no anomaly in the pipeline.

The buried pipeline map 410 refers to a map that describes a condition of the buried pipeline. The buried pipeline map 410 may include at least one node 411 and at least one edge 412.

In some embodiments, a node of the buried pipeline map 410 corresponds to a pipeline node of the buried pipeline. Node attributes of a node may include whether there are valves in an auxiliary facility at the pipeline node corresponding to the node, a count of upstream pipelines connected to the pipeline node corresponding to the node, a count of downstream pipelines connected to the pipeline node corresponding to the node, or the like.

In some embodiments, an edge of the buried pipeline map 410 corresponds to a pipeline segment. An edge exists between two nodes if a pipeline connects pipeline nodes corresponding to the two nodes. Edge attributes of an edge include the detection data and the burial depth data of the pipeline segment corresponding to the edge.

In some embodiments, the prediction model may be obtained by training with a large number of second sample data with labels. The second sample data may include a sample buried pipeline map constructed based on historical data, and the labels may be pipeline abnormal values of each node and each edge subsequently verified through actual inspections within the sample buried pipeline map. In some embodiments, the second sample data may be obtained by constructing the second sample data based on the historical data, and the labels corresponding to the second sample data may be obtained by annotating the pipeline abnormal values of each node and each edge of the sample buried pipeline map based on the historical data.

In some embodiments, the emergency supervision management platform may obtain the prediction model through training based on the second sample data and the labels. Training manners may include, but are not limited to, a gradient descent manner, or the like. Merely by way of example, the emergency supervision and management platform may input a plurality of second sample data into an initial prediction model, construct a loss function based on the labels and outputs of the initial prediction model, and then iteratively update parameters of the initial prediction model. The model training is completed when a training condition is satisfied, and the trained prediction model is obtained. The training condition may include convergence of the loss function, a count of iterations reaching a preset threshold, or the like.

In some embodiments, the emergency supervision management platform may determine a node and/or an edge with a pipeline abnormal value of 1 in the buried pipeline map output by the prediction model as the pipeline anomaly point.

In some embodiments of the present disclosure, by considering the physical positional relationships among a plurality of upstream and downstream pipeline segments, and leveraging the detection data and the burial depth data, the prediction model can determine whether a pipeline segment or pipeline node is anomalous. This approach enables rapid and accurate localization of issues in the buried pipeline, thereby contributing to maintaining the safety of the buried pipeline.

FIG. 5 is a flowchart illustrating an exemplary process for adjusting a pulse width according to some embodiments of the present disclosure.

In some embodiments, a pulse width adjustment manner may be performed by the emergency supervision management platform 130. As shown in FIG. 5, process 500 includes the following operations.

In 510, a pulse width adjustment zone of a buried pipeline may be determined based on a to-be-detected region.

The pulse width adjustment zone refers to a region involving a fiber whose distributed optical fiber pulse requires adjustment.

In some embodiments, the pulse width adjustment zone may be a portion of a region where the buried pipeline is located.

In some embodiments, the pulse width adjustment zone may be a user-specified region in the to-be-detected region, determined through user input.

In some embodiments, the emergency supervision management platform may directly designate the to-be-detected region as the pulse width adjustment zone.

In 511, an association radius may be determined based on a count of pipeline anomaly points within the to-be-detected region.

The association radius refers to a parameter that measures an extent of influence of pipeline anomalies.

In some embodiments, the emergency supervision management platform may determine the association radius based on a positive correlation between the association radius and the count of pipeline anomaly points within the to-be-detected region.

In some embodiments, the count of pipeline anomaly points within the to-be-detected region is an indicator for assessing an overall degree of anomalies in the to-be-detected region. The greater the count of pipeline anomaly points within the to-be-detected region is, the greater the degree of anomalies in the to-be-detected region is. In some embodiments, the emergency supervision management platform may determine a count of nodes and/or edges with a pipeline abnormal value of 1 in the to-be-detected region, and designate the count of nodes and/or edges as the count of pipeline anomaly points within the detection region. The pipeline abnormal value is determined by a prediction model. More descriptions regarding the pipeline abnormal value and the prediction model may be found in FIG. 4 and the related descriptions.

By appropriately adjusting the association radius based on the count of pipeline anomaly points in the to-be-detected region, the pulse width adjustment zone can be adjusted, thereby improving the spatial detection resolution of the distributed optical fiber over a wider range.

In 512, one or more pipeline segments within a range of the association radius may be determined as the pulse width adjustment zone.

In some embodiments, the emergency supervision management platform may determine a geometric distribution center of all pipeline anomaly points in the to-be-detected region as a circle center, and define a region enclosed by one or more pipeline segments within the association radius from the circle center as the pulse width adjustment zone.

In some embodiments of the present disclosure, the pulse width adjustment zone is dynamically adjusted based on the count of pipeline anomaly points within the to-be-detected region, so that the distributed optical fiber can intelligently adjust the pulse width adjustment zone according to actual pipeline anomaly points. This targeted approach enhances the spatial defect identification capability and overall monitoring reliability of the distributed optical fiber, thereby improving its monitoring accuracy.

In some embodiments, variations in burial depth may create a detection blind spot for an unmanned vehicle. Therefore, operation 513 may be optionally performed to correct the pulse width adjustment zone.

In 513, the pulse width adjustment zone may be corrected based on a burial depth of each of the one or more pipeline segments corresponding to the pulse width adjustment zone (i.e., the one or more pipeline segments within the range of the association radius). The burial depth(s) of the pipeline segment(s) corresponding to the pulse width adjustment zone may be obtained by retrieving data pre-stored by the system 100, or obtained through detection by the unmanned vehicle. More descriptions regarding the burial depth may be found in FIG. 3 and the related descriptions.

In some embodiments, the emergency supervision management platform may query a second preset table to determine a correction magnitude based on the burial depth(s) of the pipeline segment(s) corresponding to the pulse width adjustment zone. The second preset table includes burial depths and correction magnitudes corresponding to the burial depths, where the burial depths and the correction magnitudes corresponding to the burial depth are in a positive correlation. The second preset table may be set based on experience.

In some embodiments, the emergency supervision management platform may determine an adjusted association radius based on the association radius determined in operation 511 and the correction magnitude determined in operation 513 (e.g., the adjusted association radius is determined by multiplying the association radius determined in operation 511 by the correction magnitude determined in operation 513). Then, following operation 512, a new pulse width adjustment zone may be determined based on the adjusted association radius, thus achieving the correction of the pulse width adjustment zone.

In some embodiments of the present disclosure, by considering the burial depth and correspondingly adjusting the association radius to correct the pulse width adjustment zone, the system 100 dynamically compensates for signal transmission attenuation variations caused by different geological structures. This approach effectively eliminates detection blind spots induced by burial depth and significantly enhances the detection accuracy of the distributed optical fiber for the buried pipeline.

In 520, a target pulse width corresponding to the pulse width adjustment zone may be determined, and a pulse width adjustment instruction may be generated.

The target pulse width refers to a monitoring pulse width of the distributed optical fiber.

In some embodiments, the target pulse width may include a pulse width to which the distributed optical fiber within the pulse width adjustment zone needs to be adjusted.

In some embodiments, the emergency supervision management platform may determine a pulse width adjustment magnitude based on the count of pipeline anomaly points within the to-be-detected region, and generate the target pulse width based on the pulse width adjustment magnitude and a current pulse width.

For example, the emergency supervision management platform may generate the target pulse width by multiplying the pulse width adjustment magnitude by the current pulse width. The pulse width adjustment magnitude is less than 1, and the pulse width adjustment magnitude is positively correlated to the count of pipeline anomaly points within the to-be-detected region. In some embodiments, the target pulse width is smaller than the current pulse width.

The pulse width adjustment instruction refers to an instruction for adjusting the pulse width of the distributed optical fiber.

In some embodiments, the pulse width adjustment instruction may include an instruction for adjusting the target pulse width.

In some embodiments, the pulse width adjustment instruction may query a third preset table to determine the pulse width adjustment instruction based on the target pulse width corresponding to the pulse width adjustment zone. The third preset table includes target pulse widths and pulse width adjustment instructions corresponding to the target pulse widths. The third preset table may be set based on experience.

In some embodiments, the emergency supervision management platform may control, based on the pulse width adjustment instruction, a laser in the pulse width adjustment zone to operate with a current corresponding to the target pulse width. The current corresponding to the target pulse width may be determined by querying a fourth preset table based on the target pulse width. The fourth preset table includes pulse width adjustment instructions and currents corresponding to the pulse width adjustment instructions. The fourth preset table may be set based on experience.

In some embodiments, the emergency supervision management platform may send the pulse width adjustment instruction to the laser through an unmanned vehicle, the unmanned vehicle being communicatively connected to the laser. More descriptions regarding the unmanned vehicle may be found in FIG. 2 and the related descriptions.

In some embodiments, after the laser receives the pulse width adjustment instruction, the laser adjusts the pulse width of the distributed optical fiber and operates with the current corresponding to the target pulse width.

In some embodiments of the present disclosure, integrating both data detection and pulse width adjustment instruction transmission functions into the unmanned vehicle not only improves its utilization rate but also ensures the reliability of communication between the emergency supervision management platform and the distributed optical fiber.

In some embodiments of the present disclosure, the emergency supervision management platform determines at least one pulse width adjustment zone of the buried pipeline and adjusts the pulse width of the distributed optical fiber based on the to-be-detected region. This approach enhances spatial resolution accuracy while maintaining a signal-to-noise ratio threshold, thereby improving the monitoring precision of the distributed optical fiber.

In some embodiments, after updating the pulse width of the distributed optical fiber, the buried pipeline may be re-monitored based on the updated pulse width, thereby updating monitoring results.

In some embodiments, the emergency supervision management platform may obtain a second stress distribution and a second displacement distribution through the distributed optical fiber, and determine the to-be-detected region of the buried pipeline based on the second stress distribution and the second displacement distribution.

The second stress distribution refers to a distribution of stress change values of the buried pipeline relative to its initial laid state, obtained by the distributed optical fiber using the target pulse width for monitoring.

The second displacement distribution refers to a distribution of displacements of the buried pipeline relative to its initial laid position, obtained by the distributed optical fiber using the target pulse width for monitoring.

The second stress distribution is similar to the first stress distribution, and the second displacement distribution is similar to the first displacement distribution. The manner for obtaining the second stress distribution and the second displacement distribution is similar to that for obtaining the first stress distribution and the first displacement distribution. More descriptions regarding the second stress distribution and second displacement distribution may be found in more descriptions relating to the first stress distribution and first displacement distribution in operation 210 of FIG. 2.

The manner for determining the to-be-detected region of the buried pipeline based on the second stress distribution and the second displacement distribution is similar to the manner for determining the to-be-detected region of the buried pipeline based on the first stress distribution and the first displacement distribution. More descriptions regarding determining the to-be-detected region of the buried pipeline may be found in operation 210 of FIG. 2 and the related descriptions

In some embodiments of the present disclosure, re-monitoring with the distributed optical fiber at the adjusted pulse width and determining the to-be-detected region based on the second stress distribution and the second displacement distribution enables timely improvement of monitoring accuracy, resulting in a more precise identification of the to-be-detected region.

What is claimed is:

1. An Internet of Things (IoT)-based large-model system for emergency supervision of an urban lifeline gas pipeline, comprising an emergency supervision management platform, wherein the emergency supervision management platform is configured to:
control a distributed optical fiber to obtain a first stress distribution and a first displacement distribution of a buried pipeline, wherein the distributed optical fiber is located on the buried pipeline;
determine a to-be-detected region corresponding to the buried pipeline based on the first stress distribution and the first displacement distribution;
control an unmanned vehicle to detect the buried pipeline within the to-be-detected region to obtain detection data;
determine a target valve based on the detection data, and send a valve control instruction; and
control the target valve to close based on the valve control instruction.

2. The system of claim 1, wherein the emergency supervision management platform is further configured to:
determine at least one pipeline anomaly point of the buried pipeline based on the detection data; and
determine the target valve based on the at least one pipeline anomaly point.

3. The system of claim 2, wherein the emergency supervision management platform is further configured to:
determine a regulatory coverage range of at least one candidate valve, wherein the at least one candidate valve is generated based on the at least one pipeline anomaly point;
determine an influence impact value and coverage data of the at least one candidate valve based on the regulatory coverage range;
determine a control influence value of the at least one candidate valve based on the at least one pipeline anomaly point;
determine a comprehensive score of the at least one candidate valve by weighting the influence impact value and the control influence value; and
determine the target valve based on the comprehensive score and the coverage data.

4. The system of claim 3, wherein the emergency supervision management platform is further configured to:
obtain historical data of a candidate valve among the at least one candidate valve that satisfies a preset condition, wherein the historical data includes first pipeline data and second pipeline data;
determine an upstream critical pipeline and a downstream critical pipeline of the candidate valve satisfying the preset condition based on the historical data; and
generate the regulatory coverage range of the candidate valve satisfying the preset condition based on the upstream critical pipeline and the downstream critical pipeline.

5. The system of claim 2, wherein the emergency supervision management platform is further configured to:
control the unmanned vehicle to perform a burial depth detection on the buried pipeline within the to-be-detected region to obtain burial depth data;
construct a buried pipeline map based on the detection data and the burial depth data; and
determine the at least one pipeline anomaly point through a prediction model based on the buried pipeline map, the prediction model being a machine learning model.

6. The system of claim 1, wherein the emergency supervision management platform is further configured to:
determine a pulse width adjustment zone of the buried pipeline based on the to-be-detected region; and
determine a target pulse width corresponding to the pulse width adjustment zone, and generate a pulse width adjustment instruction to control a laser in the pulse width adjustment zone to operate with a current corresponding to the target pulse width.

7. The system of claim 6, wherein the emergency supervision management platform is further configured to:
obtain a second stress distribution and a second displacement distribution through the distributed optical fiber; and
determine the to-be-detected region of the buried pipeline based on the second stress distribution and the second displacement distribution.

8. The system of claim 6, wherein the emergency supervision management platform is further configured to:
send the pulse width adjustment instruction to the laser through the unmanned vehicle, wherein the unmanned vehicle is communicatively connected to the laser.

9. The system of claim 6, wherein the emergency supervision management platform is further configured to:
determine an association radius based on a count of pipeline anomaly points within the to-be-detected region; and
determine one or more pipeline segments within a range of the association radius as the pulse width adjustment zone.

10. The system of claim 9, wherein the emergency supervision management platform is further configured to:
correct the pulse width adjustment zone based on a burial depth of each of the one or more pipeline segments corresponding to the pulse width adjustment zone, wherein the burial depth is determined based on burial depth data.

11. A method for emergency supervision of an urban lifeline gas pipeline, the method being performed by an emergency supervision management platform, the method comprising:
controlling a distributed optical fiber to obtain a first stress distribution and a first displacement distribution of a buried pipeline, wherein the distributed optical fiber is located on the buried pipeline;
determining a to-be-detected region corresponding to the buried pipeline based on the first stress distribution and the first displacement distribution;
controlling an unmanned vehicle to detect the buried pipeline within the to-be-detected region to obtain detection data;
determining a target valve based on the detection data, and sending a valve control instruction; and
controlling the target valve to close based on the valve control instruction.

12. The method of claim 11, wherein the determining a target valve based on the detection data includes:
determining at least one pipeline anomaly point of the buried pipeline based on the detection data; and
determining the target valve based on the at least one pipeline anomaly point.

13. The method of claim 12, wherein the determining the target valve based on the at least one pipeline anomaly point includes:
determining a regulatory coverage range of at least one candidate valve, wherein the at least one candidate valve is generated based on the at least one pipeline anomaly point;
determining an influence impact value and coverage data of the at least one candidate valve based on the regulatory coverage range;
determining a control influence value of the at least one candidate valve based on the at least one pipeline anomaly point;
determining a comprehensive score of the at least one candidate valve by weighting the influence impact value and the control influence value; and
determining the target valve based on the comprehensive score and the coverage data.

14. The method of claim 13, wherein the determining a regulatory coverage range of at least one candidate valve includes:
obtaining historical data of a candidate valve among the at least one candidate valve that satisfies a preset condition, wherein the historical data includes first pipeline data and second pipeline data;
determining an upstream critical pipeline and a downstream critical pipeline of the candidate valve satisfying the preset condition based on the historical data; and
generating the regulatory coverage range of the candidate valve satisfying the preset condition based on the upstream critical pipeline and the downstream critical pipeline.

15. The method of claim 12, wherein the determining at least one pipeline anomaly point of the buried pipeline based on the detection data includes:
controlling the unmanned vehicle to perform a burial depth detection on the buried pipeline within the to-be-detected region to obtain burial depth data;
constructing a buried pipeline map based on the detection data and the burial depth data; and
determining the at least one pipeline anomaly point through a prediction model based on the buried pipeline map, the prediction model being a machine learning model.

16. The method of claim 11, further comprising:
determining a pulse width adjustment zone of the buried pipeline based on the to-be-detected region; and
determining a target pulse width corresponding to the pulse width adjustment zone, and generating a pulse width adjustment instruction to control a laser in the pulse width adjustment zone to operate with a current corresponding to the target pulse width.

17. The method of claim 16, further comprising:
obtaining a second stress distribution and a second displacement distribution through the distributed optical fiber; and
determining the to-be-detected region of the buried pipeline based on the second stress distribution and the second displacement distribution.

18. The method of claim 16, further comprising:
sending the pulse width adjustment instruction to the laser through the unmanned vehicle, wherein the unmanned vehicle is communicatively connected to the laser.

19. The method of claim 16, wherein the determining a pulse width adjustment zone of the buried pipeline based on the to-be-detected region includes:
determining an association radius based on a count of pipeline anomaly points within the to-be-detected region; and
determining one or more pipeline segments within a range of the association radius as the pulse width adjustment zone.

20. The method of claim 19, further comprising:
correcting the pulse width adjustment zone based on a burial depth of each of the one or more pipeline segments corresponding to the pulse width adjustment zone, wherein the burial depth is determined based on burial depth data.
